(19) United States
(12) Patent Application Publication
(10) Pub. No.: US 2008/0051023 A1
(43) Pub. Date: Feb. 28, 2008

(54) System for Ventilating and/or Tempering a Motor Vehicle

(76) Inventors: Jochen Fischle, Waiblingen (DE); Gebhard Schweizer, Leonberg (DE); Masaaki Kawaguchi, Campinas (BR); Oliveira Kleber, Mogi das Cruzes (BR)

Correspondence Address: FOLEY AND LARDNER LLP;SUITE 500, 3000 K STREET NW, WASHINGTON, DC, 20007, US

(21) Appl. No.: 11/596,039

(22) PCT Filed: May 4, 2005
(86) PCT No.: PCT/EP05/04856

§ 371 Date: Nov. 9, 2006

(30) Foreign Application Priority Data
May 13, 2004 (DE) 10 2004 024 069.8

(51) Int. Cl. B60H 3/00

(52) U.S. Cl. 454/156

(57) ABSTRACT

The invention relates to a system for ventilating and/or tempering a motor vehicle, comprising a basic version which encompasses at least one fan arrangement (2) that is part of a motor vehicle ventilation system (1). The fan arrangement (2) is provided with at least one fan wheel (6) that is placed in a multi-part air-conducting housing (5) and a motor (7) which drives said fan wheel (6). An additional ventilation system (1) is composed of a plurality of air ducts (3) and air inlet nozzles (4). The inventive system can be expanded in a modular fashion, wherefore at least one area (10, 12) of the air-conducting housing (5) is embodied in a replaceable manner.

The invention relates to a system for ventilating and/or tempering a motor vehicle according to the preamble to claim 1.

Provided in the basic version of motor vehicles is at least one fan arrangement, which supplies non-tempered ambient air and/or recirculated air to the interior of the vehicle via a ventilation system consisting of a plurality of air ducts and air inlet nozzles.

If this basic version is to be replaced by an air conditioning system, for example, the fan arrangement is usually removed and replaced by an air conditioning system with an evaporator and a heater and an associated fan arrangement. A conversion of this kind is relatively time-consuming and expensive.

The object of the invention is to make available an improved and, in particular, a more economical system that is suitable in particular for different levels of equipment in a series of vehicles.

This object is achieved by a system having the characterizing features of claim 1. Advantageous embodiments are the subject of the dependent claims.

According to the invention is a system for ventilating and/or tempering a motor vehicle with a basic version, which exhibits at least one fan arrangement that is part of a motor vehicle ventilation system, the fan arrangement exhibiting at least one fan wheel arranged in a multi-part air-conducting housing and a motor for driving this fan wheel, and the additional ventilation system consists of a plurality of air ducts and air inlet nozzles, the system being capable of expansion in a modular manner, for which purpose at least one area of the air-conducting housing is embodied in an exchangeable manner. The provision of a plurality of versions capable of being combined independently one with the other on the basis of a common basic version offers the possibility of economically extending an existing system, whether the basic version or an already extended version, in conjunction with which essentially only areas of the air-conducting housing need to be exchanged and the old component parts can be reused. A heater and/or an evaporator having a corresponding area of the air-conducting housing is preferably capable of being attached to the fan arrangement by the removal and replacement of an area of the air-conducting housing.

An air filter is preferably capable of being integrated into the air-conducting housing, which air filter is unaffected by any further modification of the system, that is to say it can also be integrated directly into the basic version.

A temperature control means is preferably also capable of being integrated into the air-conducting housing, so that the regulation of the output of the evaporator and the heater takes place as a function of the actual and reference temperatures of the interior.

For the purpose of regulating the temperature of the air to be supplied to the interior of the vehicle via a ventilation system, it is preferable for at least one tempering means, and in particular a mixing valve or a roller belt cassette, to be capable of being incorporated in the system.

The system preferably exhibits an operating control panel with at least one operating element, which is arranged in the interior of the vehicle, the operating control panel or the at least one operating element being executed in an exchangeable and/or extendable area. The system can accordingly exhibit at least one display, which is arranged in the interior of the vehicle, the display being executed in an exchangeable and/or extendable area. This permits simple expansion involving the exchange of an operating control panel, individual operating elements and/or the display, or by the removal of a blanking panel and the installation of the operating control panel, individual operating elements and/or the display.

In order to be able to provide an adequate fan output, the motor of the fan arrangement is preferably of modularly exchangeable execution, so that, if the need arises, that is to say if the flow resistance is significantly increased due to the presence of built-in components, such as very fine air filters, and if the fan output of the basic version is insufficient, it can be replaced by a variant with a greater output, for example.

The invention is explained below in detail on the basis of an illustrative embodiment with reference to the drawing. In the drawing:

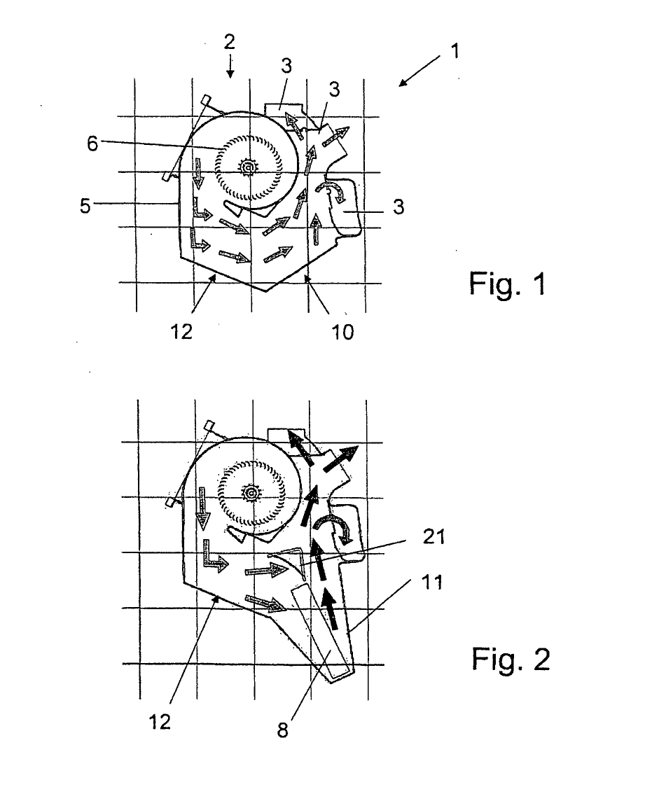

FIG. 1 depicts a schematic representation of a system for ventilating and/or tempering a motor vehicle according to the basic version,

FIG. 2 depicts a schematic representation of the system in FIG. 1 as an extended version with a heater,

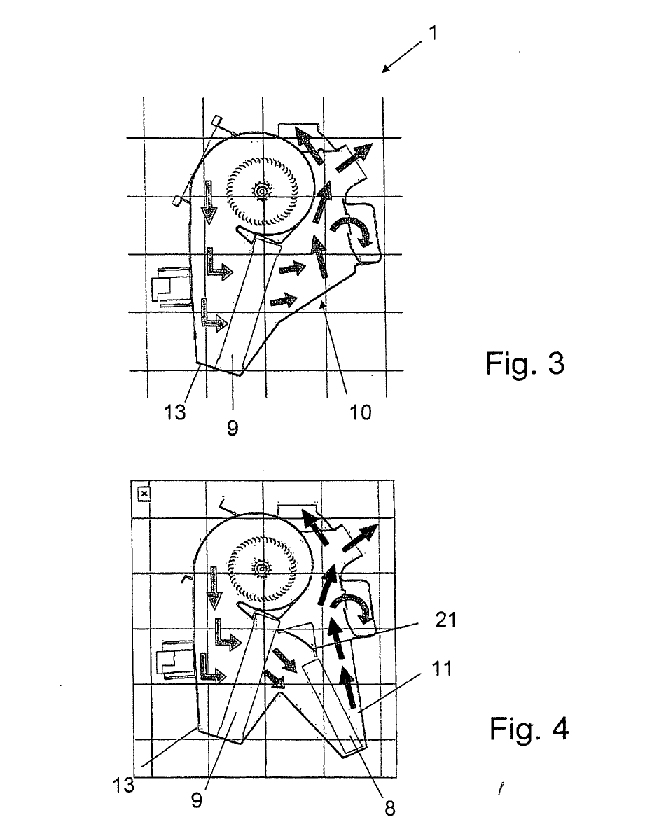

FIG. 3 depicts a schematic representation of the system in FIG. 1 as an alternative extended version with an evaporator,

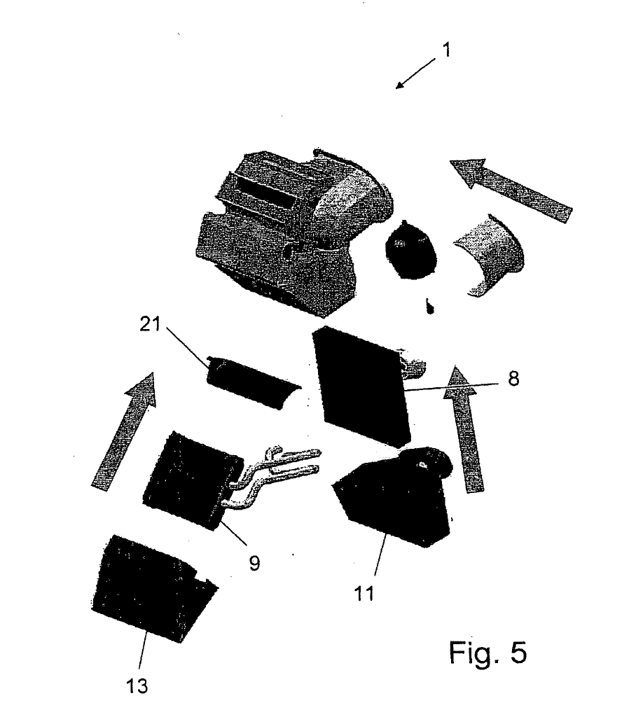

FIG. 4 depicts a schematic representation of the system in FIG. 1 as an extended version with an evaporator and a heater,

FIG. 5 depicts a form of exploded view of the system with the various component parts,

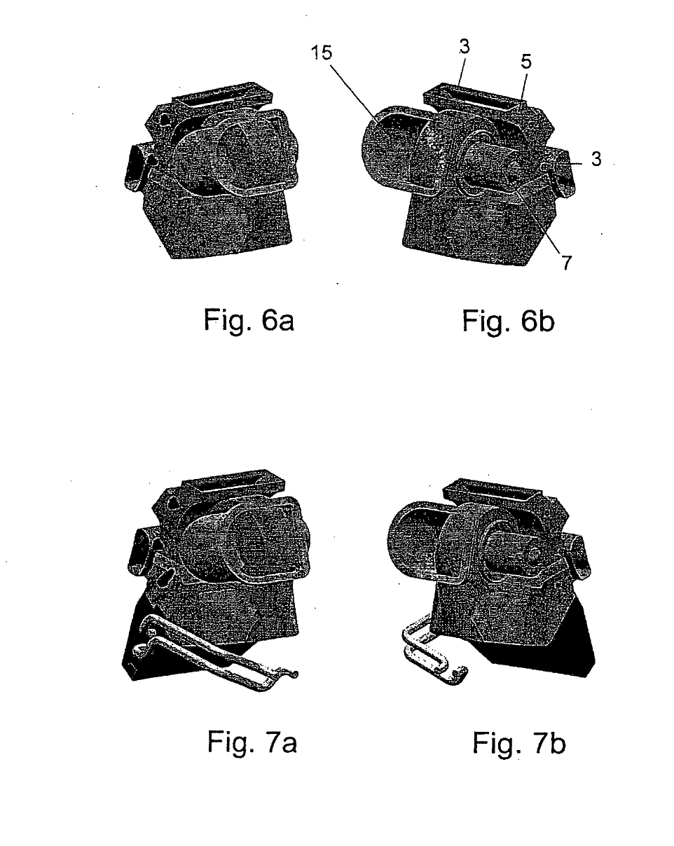

FIG. 6a and b depict various perspective views of the system according to FIG. 1,

FIG. 7a and b depict various perspective views of the system according to FIG. 2,

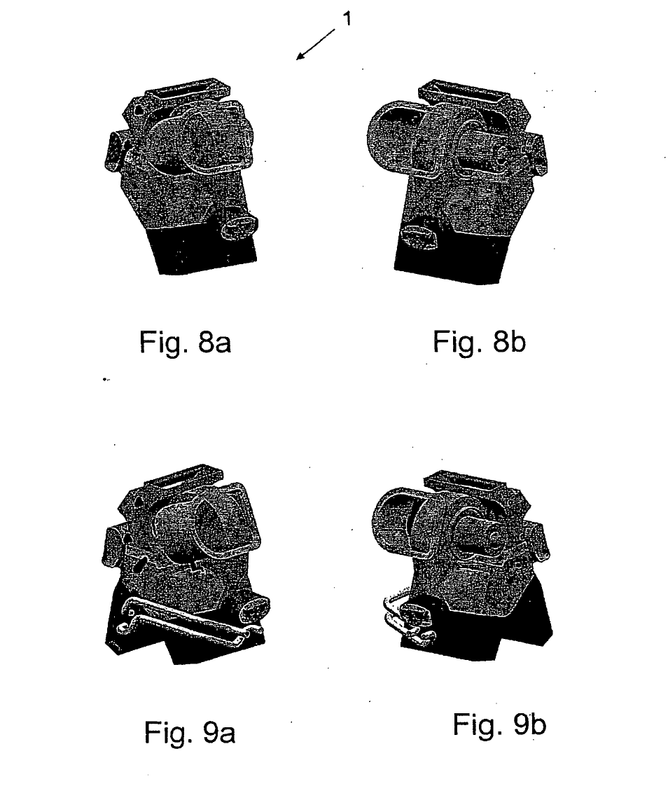

FIG. 8a and b depict various perspective views of the system according to FIG. 3,

FIG. 9a and b depict various perspective views of the system according to FIG. 4,

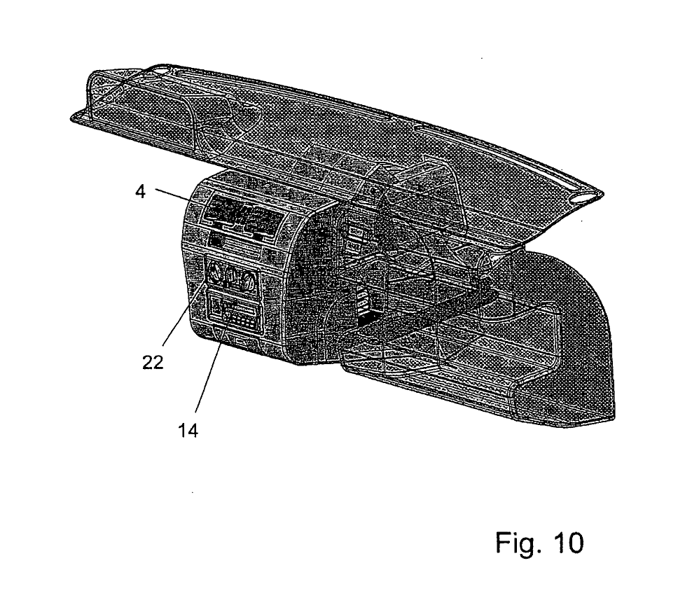

FIG. 10 depicts a perspective view of a dashboard with a part of the system in the most comprehensive version, as represented in FIG. 4,

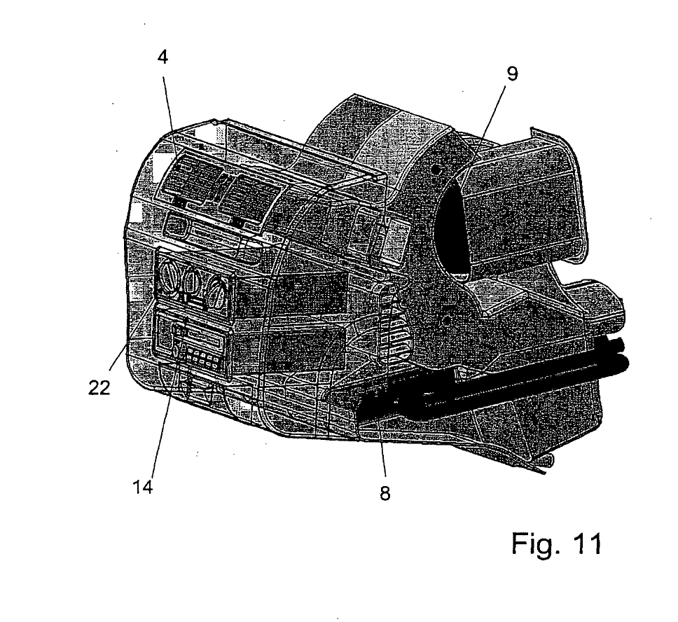

FIG. 11 depicts a perspective, enlarged view of the central area of FIG. 10,

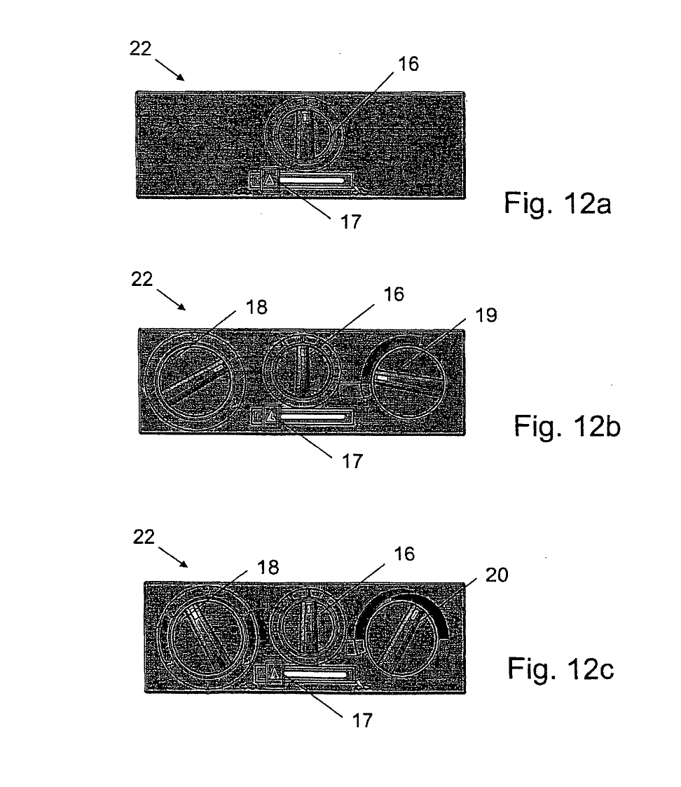

FIG. 12a depicts a view of an operating control panel for a system according to FIG. 1,

FIG. 12b depicts a view of an operating control panel for a system according to FIG. 3, and

FIG. 12c depicts a view of an operating control panel for a system according to FIG. 4.

A motor vehicle in its basic version, when considered in respect of the ventilating and tempering technology, exhibits a ventilation system 1 for ventilating the interior of the vehicle. The ventilation system 1 comprises a fan arrangement 2 and a plurality of air ducts 3 and air inlet nozzles 4, via which, should the need arise, available untempered air can be supplied to the interior of the vehicle. The fan arrangement 2 exhibits a fan wheel 6 arranged in a multi-part air-conducting housing 5 and a motor 7 for driving this fan wheel 6.

The air-conducting housing 5 is executed in such a way that individual areas can be removed from it and other, in particular otherwise executed, areas, in which additional component parts, such as a heater 8, an evaporator 9 and/or, where appropriate, also an air filter (not represented here) can be arranged. In conjunction with this, the essential areas of the fan arrangement 2, such as the fan wheel 6 in particular, remain unchanged.

In the case of the present invention, the removal of the individual areas of the air-conducting housing 5 takes place by means of separation. According to one variant, the edges of the areas to be removed are executed as predetermined rupture points, so that breaking free is possible. According to a further variant, the air-conducting housing 5 is of multi-part execution in these areas, so that the areas can be removed easily, for example without the use of tools, and in particular by releasing a clip connection.

If the basic version is to be extended with a heater 8, the area of the air-conducting housing 5 designated by 10 in FIG. 1 is separated, and the heater 8 with the area 11 of the air-conducting housing surrounding it is installed (see FIG. 2).

If the basic version is to be extended with an evaporator 9, the area of the air-conducting housing 5 designated by 12 in FIG. 1 is separated, and the evaporator 9 with the area 13 of the air-conducting housing surrounding it is installed (see FIG. 3).

If the basic version is to be extended with a heater 8 and an evaporator 9, the areas of the air-conducting housing 5 designated by 10 and 12 in FIG. 1 are separated, and the heater 8 and the ventilator 9 with the areas 11 and 13 of the air-conducting housing surrounding them are installed (see FIG. 4).

In the case of a version with air conditioning, that is to say with a heater 8 and an evaporator 9, or also, where appropriate, with only an evaporator 9, an improved means of temperature control depending on the temperature in the interior of the vehicle may be provided in place of a simple adjustment for a particular output.

The internal area of the housing 5 is preferably provided with means, for example guide slots or ridges, to receive the corresponding component parts.

To complete the conversion, holes must be made to permit a connection to be effected to the operating control panel 22 arranged on the dashboard and, where appropriate, for condensation water drainage lines in the bulkhead between the interior of the vehicle and the engine compartment, and the corresponding lines must be provided. The operating control panel 22, which in the basic version exhibits only an operating element 16 for the rotational speed of the fan, may also be exchanged to take account of the one or more new control parameters that are capable of adjustment by the user, namely the temperatures, and, where appropriate, also for different tempering zones.

In order to provide the possibility of a simple conversion, according to one variant the motor vehicle in its basic version in relation to the system also exhibits a bulkhead between the interior of the vehicle and the engine compartment, in which all orifices for the most comprehensive version of the system are provided either in the form of areas that are readily capable of being broken free, or areas that are closed by means of removable covers. In addition, the dashboard exhibits interchangeable areas 14, which exhibit operating control panels 22, operating elements (16, 17, 18, 19, 20) and/or indicators that are executed depending on the version.

Illustrative embodiments of an operating control panel 22 that is modularly extendable or interchangeable are represented in FIGS. 12a to 12c.

FIG. 12a depicts an operating control panel 22 for the basic version represented in FIG. 1 of a system for ventilating and/or tempering a motor vehicle having an operating element 16 for controlling the air quantity and an optional operating element 17 for selecting fresh air/recirculated air.

A modularly extended version of the operating control panel 22 is depicted in FIG. 12b. Provided here in addition are an operating element 18 for selecting the air distribution, for example between different areas or zones in the interior of the vehicle, and an operating element 19 for controlling the temperature of the cooling in accordance with a system for the ventilation and/or tempering of the motor vehicle represented in FIG. 3. The operating control panel 22 represented here can also be utilized in a little-changed manner for a system for the ventilation and/or tempering of the motor vehicle represented in FIG. 2, in the sense that the operating element 19 assumes the task of temperature control for the heating function.

An additional operating element 20 for the temperature control for the cooling and heating function of a version of an operating control panel 22 represented in FIG. 4 of a system for the ventilation and/or tempering of the motor vehicle is depicted in FIG. 12c. Accordingly, further possible combinations corresponding to additional functionalities can also be transferred to the operating control panel 22 in a modular configuration.

The same fan and the same air distribution are envisaged in all versions of the modular system. In particular the heater 8, the evaporator 9 and, where appropriate, a temperature-dependent facility for controlling the temperature of the interior of the vehicle are possible as extension possibilities, by the provision of an evaporator 9, a heater 8 and/or the installation of an air filter, in conjunction with which, apart from the controllability, these extensions are possible individually or in any desired combinations. In addition, an already extended version can also be extended once again simply and in an appropriate manner, in conjunction with which essentially only the version that has been extended in relation to the basic version—apart from the areas of the air-conducting housing which must be removed to permit the second extension—is extended, that is to say the component parts such as the heater 8 with the area 11 remain unchanged.

Changing the system in accordance with the invention for ventilating and/or tempering a motor vehicle from a left-hand drive to a right-hand drive version and vice versa is possible, for example, by a mirror-inverted variant of the system, in particular by the mirror-inverted replacement of the fresh air inlet housing 15, the motor 7 and the motor mounting.

### LIST OF REFERENCE DESIGNATIONS

1 ventilation system

2 fan arrangement

3 air duct

4 air inlet nozzle

5 air-conducting housing

6 fan wheel

7 motor

8 heater

9 evaporator

10 area (air-conducting housing basic version)

11 area (heater)

12 area (air-conducting housing basic version)

13 area (evaporator)

14 area (dashboard)

15 fresh air inlet housing

16 operating element for air quantity control

17 fresh air/recirculated air operating element

18 operating element for air distribution

19 operating element for tempering (cooling)

20 operating element for tempering (cooling/heating)

21 tempering means

22 operating control panel

1. System for ventilating and/or tempering a motor vehicle with a basic version, which exhibits at least one fan arrangement that is part of a motor vehicle ventilation system, the fan arrangement exhibiting at least one fan wheel arranged in a multi-part air-conducting housing and a motor for driving this fan wheel, and the additional ventilation system consists of a plurality of air ducts and air inlet nozzles, wherein the system is capable of expansion in a modular manner, for which purpose at least one area of the air-conducting housing is embodied in a replaceable manner.

2. System as claimed in claim 1, wherein a heater and/or an evaporator with a corresponding area of the air-conducting housing is capable of being installed on the fan arrangement by the removal and replacement of an area of the air-conducting housing.

3. System as claimed in claim 1, wherein an air filter is capable of being integrated into the air-conducting housing (5).

4. System as claimed in claim 1, wherein a temperature controller is capable of being integrated into the air-conducting housing.

5. System as claimed in claim 1, wherein at least a tempering means is capable of being integrated into the air-conducting housing.

6. System as claimed in claim 1, wherein the system exhibits an operating control panel with at least one operating element, which is arranged in the interior of the motor vehicle, the operating control panel being executed in a replaceable and/or extendable area.

7. System as claimed in claim 1, wherein the system exhibits an operating control panel that is capable of modular extension or exchange.

8. System as claimed in claim 1, wherein the system exhibits at least one display, which is arranged in the interior of the vehicle, the display being executed in an exchangeable and/or expandable area.

9. System as claimed in claim 1, wherein the motor of the fan arrangement is executed in a modularly exchangeable manner.

10. Motor vehicle having a system for ventilating and/or tempering a motor vehicle with a basic version, which exhibits at least one fan arrangement with a ventilation system, the fan arrangement exhibiting at least one fan wheel arranged in a multi-part air-conducting housing and the ventilation system consisting of a plurality of air ducts and air inlet nozzles, the system being executed according to claim 1, wherein the motor vehicle exhibits a bulkhead between the interior of the vehicle and the engine compartment, in which all orifices for the most comprehensive version of the system are provided and/or in that the dashboard exhibits interchangeable areas, which exhibit blanking panels or displays depending on the version.
